(19) United States
(12) Patent Application Publication
(10) Pub. No.: US 2005/0138011 A1
(43) Pub. Date: Jun. 23, 2005

(54) Meta-data storage and access techniques

(76) Inventors: Robert J. Royer JR., Portland, OR (US); John I. Garney, Portland, OR (US); Sanjeev N. Trika, Hillsboro, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/746,949

(22) Filed: Dec. 23, 2003

(51) Int. Cl. G06F 17/30

(52) U.S. Cl. 707/3

(57) ABSTRACT

Briefly, techniques to separate a file system and its related meta-data from associated data stored in a mass storage device and store the meta-data on a low latency random access storage device with approximately uniform access times.

### FIELD

The subject matter disclosed herein generally relates to techniques for storing meta-data.

### DESCRIPTION OF RELATED ART

File systems are well known techniques to manage storage and retrieval of files. Examples file systems include, but are not limited to, Microsoft file allocation table (FAT), Unix, and the Linux file system ext family. File systems typically utilize meta-data. Meta-data may describe the content, quality, condition, and other characteristics of data associated with files. Examples of meta-data include, but are not limited to, directories, file allocation tables, security features, file-names and their linkage, keywords, date-of-creation/modification, author, permissions, and a preview image. Use of a rotating media storage device (e.g., a magnetic storage device) to store meta-data may be inefficient. It is desirable to increase the speed at which meta-data can be retrieved.

### BRIEF DESCRIPTION OF THE DRAWINGS

FIG. 1 depicts an embodiment of a system that may use embodiments of the present invention.

FIG. 2 depicts a block diagram of a system in accordance with an embodiment of the present invention.

FIG. 3 depicts an example process that can be used to reserve region(s) in a storage device that stores meta-data, in accordance with an embodiment of the present invention.

FIG. 4 depicts examples of schemes that can be used for address mapping meta-data in a mass storage device and/or meta-data storage device, in accordance with embodiments of the present invention.

FIG. 5 depicts a process to access data and meta-data, in accordance with embodiments of the present invention.

FIG. 6 depicts a process to convert a logical block address to a physical address of a meta-data storage device, in accordance with embodiments of the present invention.

Note that use of the same reference numbers in different figures indicates the same or like elements.

### DETAILED DESCRIPTION

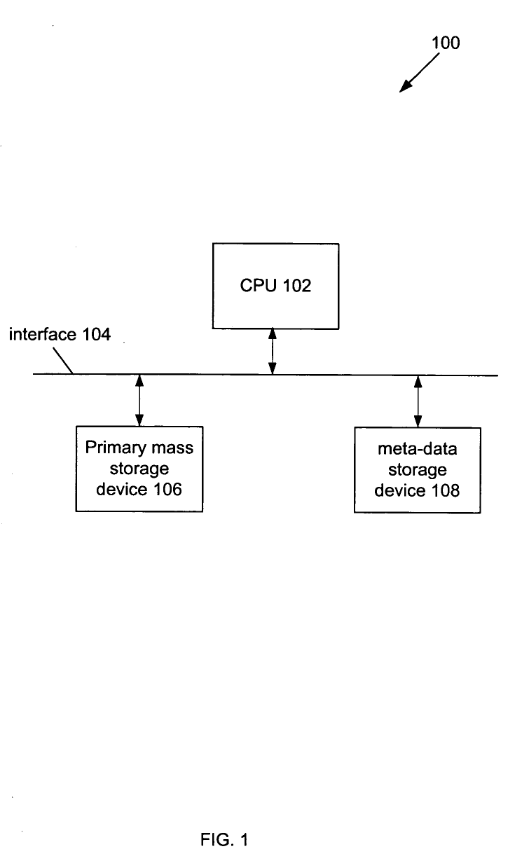

FIG. 1 depicts an embodiment of a system that may use embodiments of the present invention. System 100 may include a central processing unit (CPU) 102, interface 104, mass storage device 106, and meta-data storage device 108.

For example, interface 104 may be compatible with, but not limited to, Ten Gigabit Attachment Unit Interface (XAUI) (described in IEEE 802.3, IEEE 802.3ae, and related standards), Ethernet (described in IEEE 802.3 and related standards), Serial Peripheral Interface (SPI), I²C, universal serial bus (USB), IEEE 1394, Gigabit Media Independent Interface (GMII) (described in IEEE 802.3, IEEE 802.3ae, and related standards), Peripheral Component Interconnect (PCI) (as well as related standards), ten bit interface (TBI), serial ATA (as well as related standards), and/or parallel ATA (as well as related standards).

For example, mass storage device 106 may be implemented as any storage device including, but not limited to, a magnetic storage device or an array of magnetic storage devices. In one implementation, mass storage device 106 may store data and also may be used to store meta-data.

For example, meta-data storage device 108 may be implemented as a storage device with approximately uniform access time for randomly stored information (where the access time may be the time between receipt of a request by meta-data storage device 108 of a read or write operation and completion of such read or write operation). As compared to mass storage device 106, meta-data storage device 108 may have a lower average access time for randomly stored information. For example, meta-data storage device 108 may be implemented as a non-volatile memory device such as random access memory device (e.g., a DRAM, battery backed-up DRAM, or flash memory). In one implementation, meta-data storage device 108 may store meta-data as well as an associated address mapping table that associates meta-data with storage locations in meta-data storage device 108. Meta-data storage device 108 may further include storage regions for disk caching, reserved memory for application use, and reserved memory for a solid-state disk drive.

Storing meta-data in meta-data storage device 108 may provide an improvement over typical file-system operations that access meta-data such as searching for a file by one or more fields in the meta-data (e.g., file-name, date of creation/revision, author name, or version number) or other operations such as directory listings because access times of meta-data may be reduced on average. Searches for files by key words in the content of the file can be accelerated by including such key words in meta-data associated with the file.

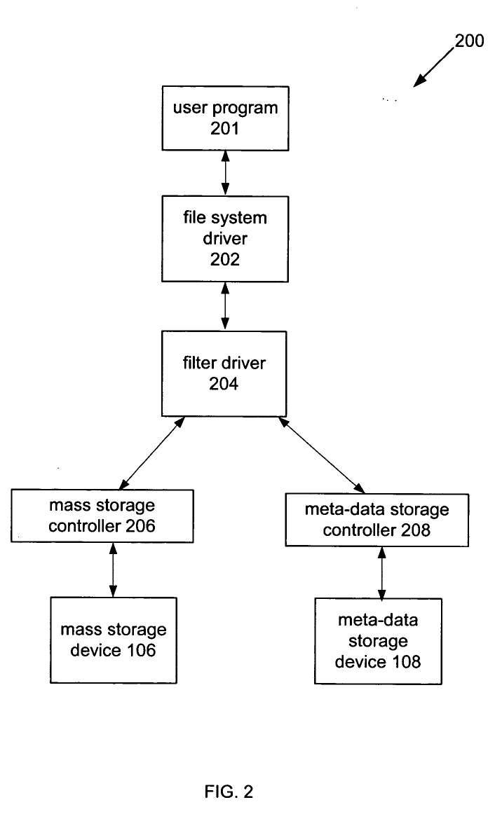

FIG. 2 depicts a block diagram of a system 200 in accordance with an embodiment of the present invention. System 200 may include user program 201, file system driver 202, filter driver 204, mass storage device controller 206, meta-data storage device controller 208, mass storage device 106, and meta-data storage device 108. User program 201, file system driver 202, filter driver 204, mass storage device controller 206, and meta-data storage device controller 208 may be implemented as any or a combination of hardwired logic, software stored by a memory device and executed by a microprocessor, firmware, an application specific integrated circuit (ASIC), and/or a field programmable gate array (FPGA).

User program 201 may attempt to store, retrieve, or perform some other action with respect to files stored in a storage device. To initiate actions with respect to files, user program 201 may provide a file name and/or file path as well as an associated action (e.g., read, write, or seek) to perform for the file.

In one embodiment, file system driver 202 may determine whether a requested operation accesses meta-data. For example, file system driver 202 may determine what data or meta-data needs to be accessed to satisfy a request from user program 201. For a meta-data access, an identified storage medium may be meta-data storage device 108 whereas for a data access, the identified storage medium may be mass storage device 106. For examples of techniques to associate meta-data with a requested file or directory, see publications describing the Microsoft FAT, Linux, and/or Unix.

In one embodiment, filter driver 204 may transfer to the proper storage device controller a request for meta-data or data based on (1) the identity of the storage medium that stores meta-data or data and (2) a logical block address in the storage medium of the meta-data or data. For example, the storage device controller may be mass storage device controller 206 or meta-data storage device controller 208. For example, filter driver 204 may determine a logical block address of the meta-data or data based on the file name, file path, and requested action.

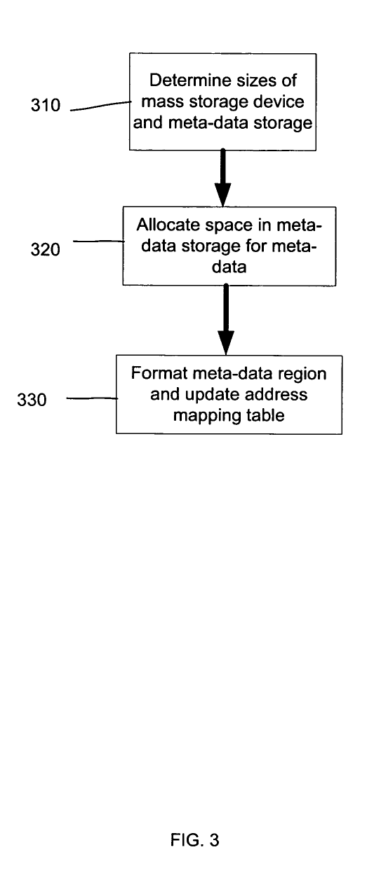

In one embodiment, filter driver 204 may request allocation for meta-data storage in meta-data storage device 108 in response, for example, to a request to access meta-data or a request to allocate meta-data storage in meta-data storage device 108. To initiate meta-data allocation, filter driver 204 may request meta-data storage controller 208 to reserve a storage region in meta-data storage device 108 for meta-data. For example, to request allocation for meta-data storage in meta-data storage device 108, the process described with respect to FIG. 3 may be used, although other techniques may be used.

Mass storage device controller 206 may manage reading and writing of data within mass storage device 106. Meta-data storage device controller 208 may reserve region(s) in meta-data storage device 108 for storing meta-data and update the address mapping table. Meta-data storage device controller 208 may modify region(s) reserved in meta-data storage device 108 for storing meta-data as well as update the address mapping table. For example, meta-data storage device controller 208 may designate meta-data for storage in meta-data storage device 108 (mark meta-data as “do not evict”) but allow redundant copies in other storage devices.

FIG. 3 depicts an example process that can be used to reserve region(s) in meta-data storage device 108 for storing meta-data as well as to update the address mapping table, in accordance with an embodiment of the present invention. The process of FIG. 3 may be initiated at least in response to a request to initialize reserve region(s) in meta-data storage device 108 or in response to a request to access meta-data that is not stored in meta-data storage device 108.

Action 310 may include determining available storage capacity of mass storage device 106 and meta-data storage device 108. For example, mass storage device controller 206 and meta-data storage device controller 208 may provide available storage capacity of respective mass storage device 106 and meta-data storage device 108.

Action 320 may include allocating a region of addressable locations in meta-data storage device 108 for storing meta-data. For example, based on the available storage capacity of mass storage device 106 and meta-data storage device 108, action 320 may determine a size and type of meta-data that can be stored in meta-data storage device 108. For example, action 320 may initially allocate table and file system types of meta-data, although other types of meta-data may be allocated based, at least, on the available storage capacity of mass storage device 106 and meta-data storage device 108.

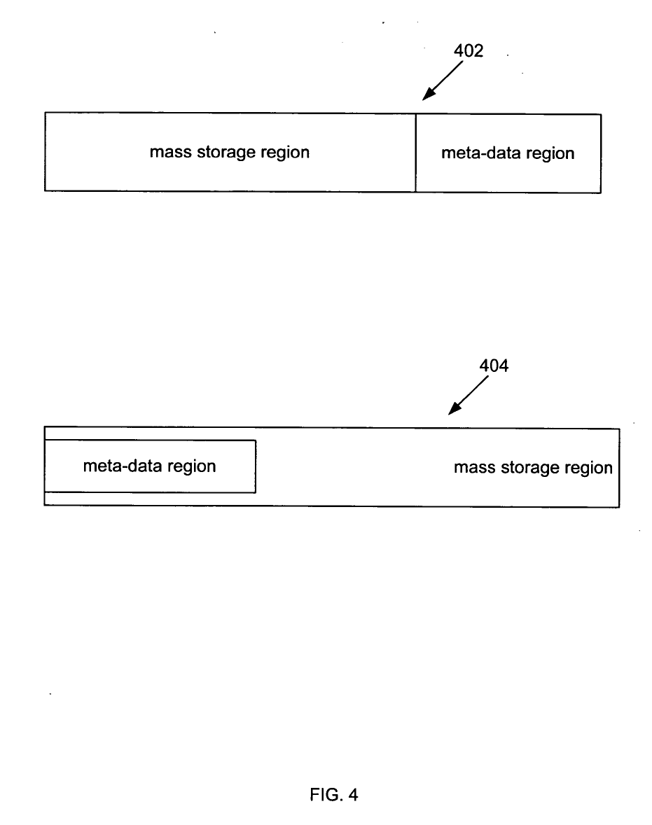

For example, FIG. 4 depicts examples of schemes that can be used for address mapping meta-data in mass storage device 106 and meta-data storage device 108, in accordance with embodiments of the present invention. In scheme 402, unique addresses are provided for storing meta-data in meta-data storage device 108 as well as for storing data in mass storage device 106. In scheme 404, an address for meta-data may correspond to an addressable storage location in both mass storage device 106 and meta-data storage device 108 so that meta-data may be stored in both mass storage device 106 and meta-data storage device 108. However, under scheme 404, in response to requests to access meta-data, meta-data may be accessed from meta-data storage device 108.

Action 330 may include formatting the allocated region in the meta-data storage device 108 for meta-data storage in accordance with meta-data specifications, such as Microsoft file allocation table (FAT), Unix, and/or Linux file system ext family, and updating the address mapping table.

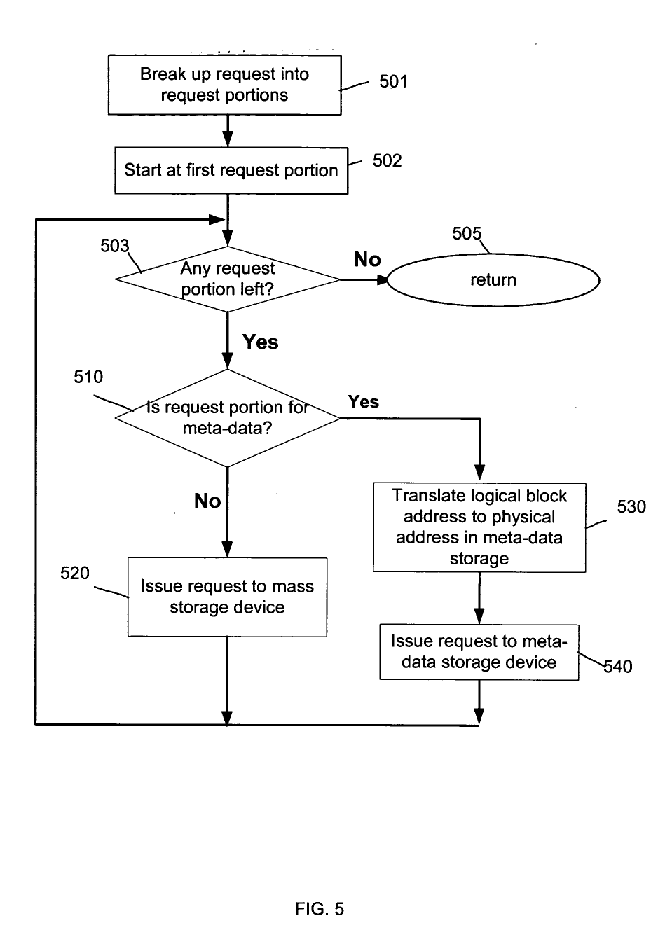

FIG. 5 depicts a process to access data and meta-data, in accordance with embodiments of the present invention. Action 501 may include breaking up a file access request into request portions. For example, the file access request may include request portions to access meta-data and/or data. A request for a file or directory access may be broken down into request portions that are either completely meta-data requests or completely data requests.

Action 502 may include processing a first request portion included with a file access request. Action 503 may follow action 502.

Action 503 may include determining whether any request portions have not been processed. If any request portion has not been processed, action 510 may follow action 503. If all request portions of the file access request have been processed, action 505 may follow action 503.

Action 505 may include returning to the routine that called the process of FIG. 5.

Action 510 may include determining whether a request portion is a request for meta-data. For example, based on the file name, file path, and requested action, the process may determine a logical block address from which to retrieve meta-data or data. Accordingly, in one implementation, action 510 may include determining whether the current request portion is for meta-data based on the logical block address. As illustrated by schemes 402 and 404 (FIG. 4), a range of logical block addresses may correspond to storage locations for meta-data.

For example, in one implementation, action 510 may utilize a look-up-table that associates file names with associated meta-data storage locations and thereby may determine if a request portion includes a request for meta-data. If the file access request includes a request for meta-data, then action 530 may follow action 510. If the file access request does not include a request for meta-data, then action 520 may follow action 510.

Action 520 may include issuing a request to access data stored at a specified logical block address to mass storage device 106. For example, action 520 may include iteratively accessing meta-data (e.g., directory structure and file allocation tables) to determine storage location(s) (e.g., logical block address) and a storage medium for the data associated with the file access request.

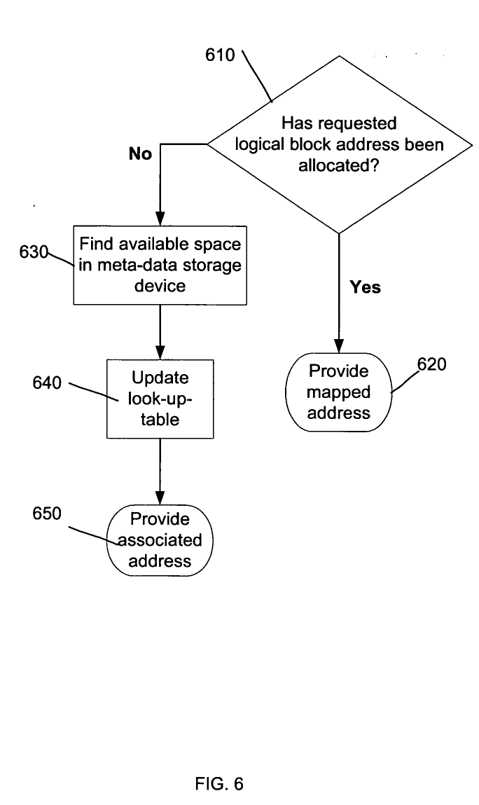

Action 530 may include translating a logical block address to a meta-data storage address. For example, action 530 may use the process described with respect to FIG. 6, although other techniques may be used. Action 540 may follow action 530. Action 540 may include issuing a request to access meta-data from a storage location specified in action 530 from meta-data storage device 108.

FIG. 6 depicts a process to convert a logical block address to a physical address in a meta-data storage device, in accordance with embodiments of the present invention. Action 610 may include querying a look-up-table that associates logical block addresses with physical addresses in meta-data storage device 108 to determine if the requested logical block address has been allocated in the look-up-table. If the requested logical block address has been allocated in the look-up-table, action 620 may follow action 610. If the requested logical block address has not been allocated in the look-up-table, action 630 may follow action 610.

Action 620 may include providing from the look-up-table a physical address in meta-data storage device 108 associated with the provided logical block address.

Action 630 may include associating an available physical address in meta-data storage device 108 with the provided logical block address. Action 640 may follow action 630. Action 640 may include updating the look-up-table to include the association(s) determined in action 630. Action 650 may follow action 640. Action 650 may include providing the physical address associated with the provided logical block address.

The drawings and the forgoing description gave examples of the present invention. While a demarcation between operations of elements in examples herein is provided, operations of one element may be performed by one or more other elements. The scope of the present invention, however, is by no means limited by these specific examples. Numerous variations, whether explicitly given in the specification or not, such as differences in structure, dimension, and use of material, are possible. The scope of the invention is at least as broad as given by the following claims.

1. A method comprising:
allocating storage capacity for meta-data in a meta-data storage device;
receiving a request to access a file; and
requesting access to meta-data in response to the file including an access to meta-data.

2. The method of claim 1, wherein the allocating storage capacity further comprises:
determining an initial region allocable for meta-data storage in the meta-data storage device;
formatting a region of the meta-data storage device for meta-data storage; and
updating a table that associates meta-data with storage locations in the meta-data storage.

3. The method of claim 1, wherein the requesting access to meta-data further comprises:
selectively providing a first address for meta-data in response to the file including an access to meta-data; and
selectively translating the first address into a second address in response to an association between the first and second addresses, wherein the second address identifies a storage location in the meta-data storage device.

4. The method of claim 3, wherein the translating further comprises:
selectively allocating a third address in available storage in the meta-data storage device in response to the first address not being associated with any address in the meta-data storage device; and
associating the first address with the selectively allocated third address.

5. The method of claim 1, wherein the meta-data storage device comprises a non-volatile storage device with approximately similar access times for randomly requested meta-data

6. The method of claim 1, further comprising accessing meta-data using the meta-data storage device.

7. The method of claim 1, wherein the allocating storage capacity for meta-data comprises allocating addressable storage locations in the meta-data storage device and at least another storage device.

8. The method of claim 7, further comprising storing meta-data in the meta-data storage device and the at least another storage device.

9. The method of claim 1, wherein the request comprises a file name and wherein the requesting access to meta-data is based on the file name.

10. The method of claim 1, further comprising determining an address associated with the request to access the file and wherein the requesting access to meta-data is based on the address.

11. The method of claim 1, further comprising:
selectively associating meta-data with the request to access the file; and
requesting access to data based on the meta-data.

12. The method of claim 1, wherein the meta-data storage device comprises a non-volatile storage device with approximately similar access times for randomly stored meta-data and further comprising a mass storage device to store data.

13. The method of claim 1, wherein the meta-data comprises file system meta-data.

14. A system comprising:
a processing unit;
a first storage device;
a second storage device;
an interface device to provide intercommunication between the processing unit and the first and second storage devices; and
an application storage device including machine readable instructions that when executed instruct the processing unit to:
allocate storage capacity for meta-data in a meta-data storage device,
receive a request to access a file, and
request access to meta-data in response to the file including an access to meta-data.

15. The system of claim 14, wherein the interface device comprises an interface compatible with serial ATA.

16. The system of claim 14, wherein the interface device comprises an interface compatible with PCI express.

17. The system of claim 14, wherein the first storage device comprises a non-volatile storage device with approximately similar access times for randomly stored meta-data.

18. The system of claim 14, wherein the second storage device comprises a mass storage device to store data.
